(19) United States
(12) Patent Application Publication
(10) Pub. No.: US 2009/0283505 A1
(43) Pub. Date: Nov. 19, 2009

(54) INTERFACE SUSPENSION FOR ALLOY BASED LASER WELDING

(75) Inventors: Vancho Naumovski, Shelby Township, MI (US); Dragos Catanescu, Rochester Hills, MI (US)

Correspondence Address: REISING ETHINGTON P.C., P O BOX 4390, TROY, MI, 48099-4390, US

(73) Assignee: DR Industries, Novi, MI (US)

(21) Appl. No.: 12/534,510

(22) Filed: Aug. 3, 2009

Related U.S. Application Data
(63) Continuation-in-part of application No. 11/180,793, filed on Jul. 13, 2005.

(51) Int. Cl. B23K 26/20; C10M 125/04

(52) U.S. Cl. 219/121.64; 508/150

(57) ABSTRACT

An interface suspension facilitates laser welding of a first metal having a first zinc coating to a second metal having a second zinc coating. The interface suspension includes a petrolatum base and a plurality of spherules suspended in the petrolatum base. The interface suspension melts when the zinc coated metals are welded to allow the plurality of spherules to maintain a gap between the first and second metals. This allows vapors of zinc to escape through the gap during the weld process to maintain the integrity of a resulting weld.

This patent application is a continuation-in-part of a United States patent application having application Ser. No. 11/180,793, the disclosure of which is hereby incorporated by reference.

### BACKGROUND ART

1. Field of the Invention

The invention relates generally to a laser welded joint. More particularly, the invention relates to a suspension applied to a welded joint to facilitate the welding thereof.

2. Description of the Related Art

Welding is the process of using heat to join two components together. In some instances, pressure is used in the process. In other methods, a third material is used. The process of welding components together is a very effective process when assembling structures because the resulting union of the parts is as strong or stronger than it would have been using other means to fasten the parts together.

Another reason why parts are welded together as opposed to other means is due to the aesthetic result of welding. When finished, the parts joined together often look like a single part. This provides a look that is pleasing. In some instances, this enhanced look can also be useful in a functional sense. This is true when fluids flow past the joined parts and the finished composite part does not create turbulences or flow disruptions at the weld position.

When the parts being welded are galvanized steel, there is a potential for poor weld quality if the source of heat is elevated rapidly and concentrated in a specific area. This typically occurs when a laser or electron beam is used in the welding process to heat the metals. The poor welding results occur because a laser weld occurs rapidly and the vaporization of certain materials in the weld area are trapped within the molten material created by the laser beam. In these situations, the zinc material used in the galvanization of the metal has a lower melting point resulting in the rapid vaporization of that metal while continued energy is being impinged upon the metal to melt the steel or iron.

U.S. Pat. No. 3,969,604 discloses a method for joining galvanized steel metal through a welding process wherein a flux material is deposited on the area in which the welding is to occur. This flux material is characterized by a melting temperature that is substantially the same or higher than the steel parts. When the flux material is placed in the weld location, a high energy density beam, e.g., a laser beam, impinges the area allowing the welding process to occur while preventing vapor created by the melting of the zinc to be trapped within the welding materials allowing for a smoother finish.

U.S. Pat. No. 6,479,168 discloses a method for laser lap welding a pair of metal members together. In particular, the welded joint includes two galvanized sheets of metal that are coated with zinc. A metal foil is placed between the two galvanized sheets of metal. The copper metal foil is a sheet of copper having a thickness of 0.0035 to 0.0045 inches thick. Copper is used in the foil because its melting point allows it to react with the zinc coating on the galvanized steel sheets to reduce the volatility during the weld process. This method is, however, cumbersome in that copper metal foil is difficult to apply and maintain in the specific area that is to be welded. In addition, much of the copper is not used and, therefore, wasted during the laser welding process.

In addition to these two methods for applying an intermediate material between two sheets of metal to be laser welded, there is a third that uses a copper powder mixed with oil. The copper powder/oil mixture is applied to the area that needs to be welded. This method of introducing an intermediate material to facilitate the welding of two galvanized sheets of metal is cumbersome for several reasons. First, it is difficult to control the application of oil on a sheet of galvanized metal when the surface to which the oil is being applied is not horizontal. Much of the oil and copper powder run off. Another disadvantage of the oil/copper powder combination is the size of the particulate is so small that it does not create a gap between the two sheets of metal being welded. Powder is defined as being less than 40 microns. In addition, particulate that makes up a powder has no defined shape because the powder is created in a pulverization process. Some of the particles are flakes and others are multifaceted. Any type of consistency in separation, if separation were possible, would not be consistent. Because the oil and copper powder are so small and fluid, the two sheets of galvanized steel may be too close together to facilitate a proper, non-violent weld.

U.S. Pat. No. 4,541,876 discloses a paste composition that assists in a brazing process. Brazing is different than welding because the braze process results in the creation of a different composite material. The paste disclosed in U.S. Pat. No. 4,541,876 requires a high copper content to ensure there is enough copper present to form the braze. This paste will not work well when laser welding because the strength of a weld created with such a paste will compromise the strength of the resulting weld.

### SUMMARY OF THE INVENTION

An interface suspension facilitates laser welding of a first metal having a first zinc coating to a second metal having a second zinc coating. The interface suspension includes a petrolatum base and a plurality of spherules suspended in the petrolatum base. The interface suspension melts when the zinc coated metals are welded to allow the plurality of spherules to maintain a gap between the first and second metals. This allows vapors of zinc to escape through the gap during the weld process to maintain the integrity of a resulting weld.

### BRIEF DESCRIPTION OF THE DRAWINGS

Advantages of the invention will be readily appreciated as the same becomes better understood by reference to the following detailed description when considered in connection with the accompanying drawing, wherein:

FIG. 1 is a cross-sectional side view of a sheet of galvanized metal with an interface suspension applied thereto;

FIG. 2 is a cross-sectional side view of two sheets of galvanized metal positioned on either side of the interface suspension;

FIG. 3 is a cross-sectional side view of two galvanized metal sheets at a beginning stage of the laser welding process with the interface suspension squeezed therebetween and forming a gap between the two galvanized metal sheets; and

FIG. 4 is a cross-sectional side view of the two sheets of galvanized metal during the final stages of laser welding.

### DETAILED DESCRIPTION OF THE PREFERRED EMBODIMENT

The invention is an interface suspension 10. The interface suspension 10 is used to facilitate laser welding of a first metal 12 having a first zinc coating 14 to a second metal 16 having a second zinc coating 18. In the embodiment shown, the first metal 12 and the second metal 16 are steel sheet metal that are coated with zinc on both sides. It should be appreciated by those skilled in the art that the first 12 and second 16 metal pieces may be other forms of metal fabricated from metal others than steel and may only be partially coated with zinc. The zinc coatings 14, 18 are used to inhibit corrosion of the base component, i.e., the first 12 and second 16 metals. This combination of a zinc coated piece of steel is commonly referred to as galvanized steel.

Due to the low melting and boiling points of zinc, the zinc in the first 14 and second 18 coatings is vaporized quickly when subjected to laser welding procedures. In the prior art, those vapors created at the weld position are trapped in the molten metal that is creating the weld. The trapped zinc vapors increase the porosity of the weld line, weakening it and making it look less desirable.

The interface suspension 10 creates a controlled gap 20 between the first 14 and second 18 zinc coatings. The gap 20 provides a sufficient space for the vaporized zinc to escape from between the first 12 and second 16 metals. These vapors are allowed to escape, which eliminates the vapors from being trapped in the weld.

The interface suspension 10 includes a petrolatum base 22 and a plurality of metal spherules 24. The metal spherules 24 are suspended in the petrolatum base 22, a semi-solid hydrocarbon base in one embodiment, such that the interface suspension 10 melts when laser welding to allow the vapors released by the first 14 and second 18 zinc coatings when they are boiling to escape by moving around and past the plurality of metal spherules 24 that maintain the gap 20 between the two metals 12, 16.

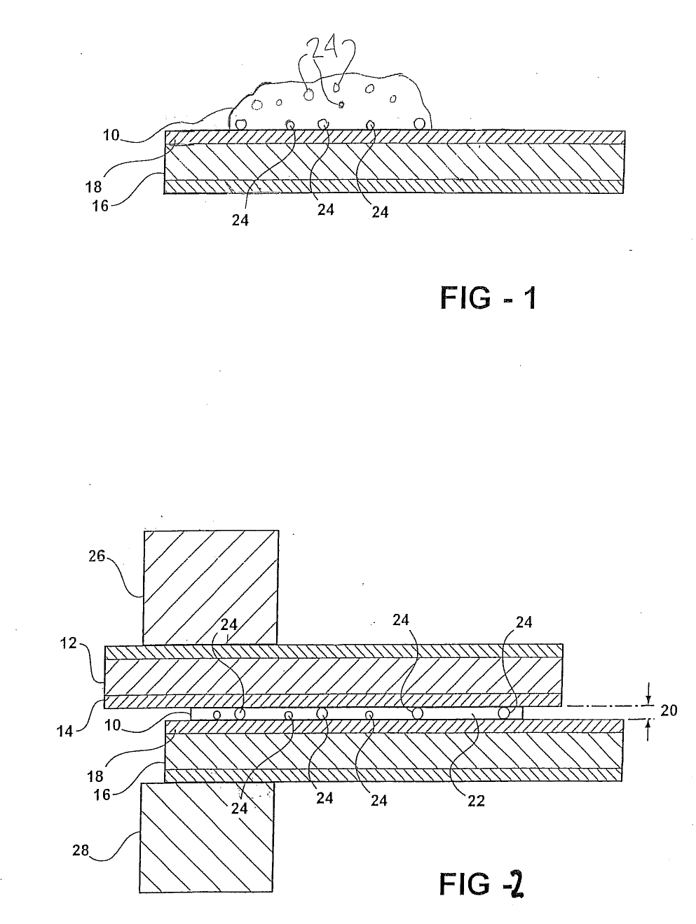

FIGS. 1 through 4 illustrate an example method of how a laser weld occurs when using two sheets of galvanized metal 12, 16. In this example, the interface suspension 10 is applied to one of the sheets of galvanized metal 16. Because the interface suspension 10 is viscous, it does not run off the sheet of galvanized metal 16.

Referring to FIG. 2, another sheet of galvanized metal 12 is placed over the interface suspension 10 and the first galvanized sheet of metal 16. This step tends to flatten the interface suspension 10.

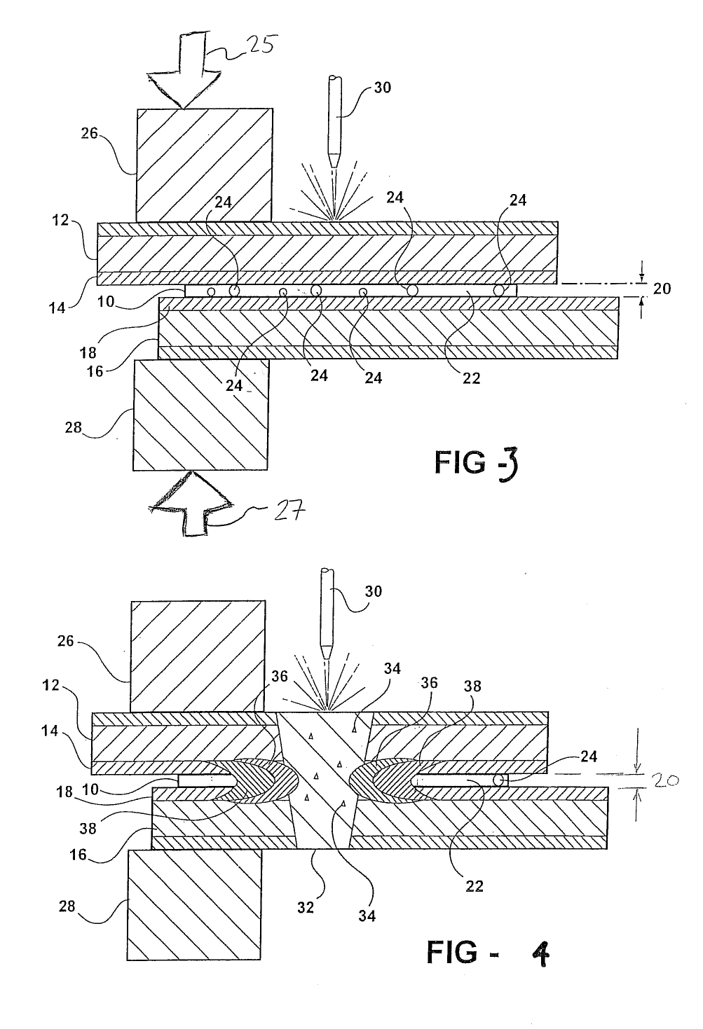

Referring to FIG. 3, a clamping pressure is applied adjacent the weld position. The clamping pressure, graphically illustrated by force arrows 25, 27 being applied to blocks 26, 28 forces the first metal 12 and the second metal 16 together minimizing the amount of interface suspension 10 therebetween to approximately the same distance as the diameter of the spherules 24. In this example, the first metal 12 extends laterally over a surface area different than the second metal 16. An opportunity for the first 12 and second 16 metals to be coaxial is also contemplated. In addition, it should be noted that one of the pressure blocks 28 extends out beyond a peripheral edge of the second metal 16. This is shown by way of example and the applied pressure may also be applied fully within the periphery of either the first 12 or second 16 metals.

A laser beam, graphically represented at 30, impinges on one of the first 12 and second 16 metals. The laser beam 30 is directed to a position exposed adjacent the pressure blocks 26, 28 because that is the location that the first 12 and second 16 metals are at their proper separation distance equal to the desired gap 20.

Referring to FIG. 4, the laser beam 30 has impinged enough energy upon the first 12 and second 16 metals such that a molten pool of metal 32 extends between the first 12 and second 16 metals. The molten pool of metal 32 includes minute traces of un-expelled zinc 34 therein. Within this area, the minute traces of un-expelled molten metal spherules 24 and the minute traces of the un-expelled vapors created by the zinc coatings 14, 18 combine or fuse together to form a secondary metal alloy 36. The secondary metal is a combination of the material that forms the metal sheets 12, 16, the molten spherules 38 and the boiling zinc. By selecting a material for the spherules 24 that has a melting point similar to that of the sheets of galvanized metal 12, 16, the spherules 24 maintain the gap 20 therebetween and provide the opportunity for the boiling and vaporized zinc to escape from between the sheets of galvanized metal 12, 16 and the molten pool of metal 32. The maintenance of the gap 20 allows the vapors to be removed so that those vapors will not interfere with the smooth laser welding of the first 12 and second 16 metals.

The petrolatum base 22 that does not melt creates a seal around the heat affected zone 32 and seals it from the elements. This helps prevent corrosion from occurring resulting in a longer life for the weld joint.

The plurality of metal spherules 24 defines diameters in the range between 75 microns and 250 microns. This range is the ideal range to define the gap 20 and by utilizing spherules 24 of this size ensures the gap 20 is at a preferred distance.

The metal spherules 24 may be fabricated from any metal suitable for melting at a temperature that is higher than the boiling point of zinc, 907° Celsius. In an alternative embodiment, the metal spherules 24 may be replaced with silica spherules (not shown) or a combination of the two materials.

The petrolatum base 22 is within the range of 70% and 99% of the weight of the interface suspension 10. Therefore, the metal spherules comprise the remaining 30% to 1% by weight of the interface suspension 10. Having the metal spherules 24 in such ranges ensures that content of the metal spherules 24 in the metal alloy formed in the molten pool of metal 32 is minimal and does not affect the physical properties of the weld. In one example, the petrolatum base 22 is 80% of the interface suspension with the plurality of metal spherules comprising the remaining 20%. The petrolatum base 22 is defined by having a melting point above 35° C.

Because the petrolatum base 22 has a natural thick consistency at room temperatures, once the plurality of spherules 24 are mixed into the petrolatum base 22, there is no need to remix the interface suspension 10 to maintain the proper consistency of the interface suspension 10 prior to its usage in a laser welding process. The interface suspension 10 may be packaged in a standard, open ended style container of various capacities, i.e., 55, 10 and 5 gallon barrels or drums. These containers (not shown) will be sealed, capped and labeled according to the Petrolatum International Transportation Regulations. The interface suspension 10 is fabricated through a mixing procedure which minimizes or prevents the entrapment of ambient gases therein.

Prior to the actual welding of the two metals 12, 16, the interface suspension 10 is applied to one of the first 12 and second 16 metals. Because the interface suspension 10 utilizes a petrolatum base 22, the interface suspension 10 adheres to the surface of the metal 12, 16 to which it is applied. The interface suspension 10 will remain in place as long as the temperature does not reach the melting point of the petrolatum base 22, namely a temperature previously mentioned range of above 35° C.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. An interface suspension for facilitating the laser welding of a first metal having a first zinc coating to a second metal having a second zinc coating, said interface suspension comprising:
a petrolatum base; and
a plurality of spherules suspended in said petrolatum base such that said interface suspension melts when laser welding to allow said plurality of spherules to maintain a gap between the first and second metals allowing vapors of zinc to escape through the gap during the weld process to maintain the integrity of a resulting weld.

2. An interface suspension as set forth in claim 1 wherein said plurality of spherules is between 1% and 30% by weight of said interface suspension.

3. An interface suspension as set forth in claim 2 wherein said petrolatum base is between 70% and 99% by weight of said interface suspension.

4. An interface suspension as set forth in claim 3 wherein said plurality of spherules define diameters in the range between 75 microns and 250 microns.

5. An interface suspension as set forth in claim 4 wherein said plurality of spherules are fabricated from copper.

6. An interface suspension as set forth in claim 4 wherein said plurality of spherules are fabricated from silver.

7. An interface suspension as set forth in claim 4 wherein said plurality of spherules are fabricated from nickel.

8. An interface suspension as set forth in claim 4 wherein said plurality of spherules are fabricated from silica.

9. An interface suspension as set forth in claim 7 wherein said petrolatum base melts at a temperature above 35° C.

10. A method for welding a first galvanized sheet of metal to a second galvanized sheet of metal using an interface suspension having a petrolatum base and a plurality of spherules suspended therein, the method comprising the steps of:
applying the interface suspension to one of the galvanized sheets of metal;
placing the other of the galvanized sheets of metal over the one galvanized sheet of metal and the interface suspension;
applying a force to the galvanized sheets of metal to reduce the thickness of the interface suspension down to a single layer of spherules and the petrolatum base; and
welding the galvanized sheets of metal together to create a weld between the galvanized sheets of metal.

11. A method as set forth in claim 10 including the step of creating a gap between the galvanized sheets of metal defined by a diameter of one of the layer of spherules.

12. A method as set forth in claim 11 wherein the step of creating a gap provides a path for vapors forming during the step of welding to escape therepast.

13. A method as set forth in claim 12 wherein the step of welding includes a vapor free environment to prevent the formation of the weld with vapors trapped therein.

14. A method as set forth in claim 13 wherein the petrolatum base seals the weld and protects the weld from corrosion.
